(19) United States
(12) Patent Application Publication
(10) Pub. No.: US 2010/0136947 A1
(43) Pub. Date: Jun. 3, 2010

(54) METHOD AND SYSTEM FOR EMERGENCY CALL SERVICE IN UNLICENSED MOBILE ACCESS NETWORK

(75) Inventors: Taig Jong YOO, Gyeonggi-do (KR); Dong In HA, Seoul (KR); Deog Gwen KANG, Gyeonggi-do (KR); Han Vit KANG, Gyeonggi-do (KR)

Correspondence Address: CHA & REITER, LLC, 210 ROUTE 4 EAST STE 103, PARAMUS, NJ, 07652, US

(73) Assignee: SAMSUNG ELECTRONICS CO., LTD., Gyeonggi-Do (KR)

(21) Appl. No.: 12/629,251

(22) Filed: Dec. 2, 2009

(30) Foreign Application Priority Data
Dec. 3, 2008 (KR) 10-2008-0121810

(51) Int. Cl. H04M 11/04

(52) U.S. Cl. 455/404.2

(57) ABSTRACT

A method and system for an emergency call service in an unlicensed mobile access (UMA) network are disclosed. The emergency call service method includes: receiving, by a mobile terminal on an unlicensed network, an emergency call; forwarding, by the unlicensed network, the emergency call and an AP (access point) list related to an AP associated with the mobile terminal to a core network; searching for, by the core network, location information of the mobile terminal corresponding to the AP list; and sending, by the core network, an emergency report containing the location information of the mobile terminal to a safety manager.

### CLAIMS OF PRIORITY

This application claims priority to an application entitled “METHOD AND SYSTEM FOR EMERGENCY CALL SERVICE IN UNLICENSED MOBILE ACCESS NETWORK” filed in the Korean Intellectual Property Office on Dec. 3, 2008 and assigned Serial No. 10-2008-0121810, the contents of which are incorporated herein by reference.

### BACKGROUND OF THE INVENTION

1. Field of the Invention

The present invention relates generally to an emergency call service and, more particularly, to a method and system that enables a mobile terminal to place an emergency call service to any networks.

2. Description of the Related Art

An emergency call service refers to a public service that enables an emergency call placed by a person in a difficult or dangerous situation to be automatically routed to a nearby public safety answering point (PSAP) or public safety agency (PSA).

In recent years, both wired and wireless communication networks have rapidly evolved into AII-IP (Internet Protocol) networks, causing worldwide popularization of Internet telephony services. Internet telephony services became popular to many consumers due to lower telephony costs. However, Internet telephony has drawbacks in terms of consumer protection, particularly, in handling an emergency call owing to inherent characteristics of IP-based networks.

The existing Internet telephony utilizing IP-based networks may have difficulty in the areas of location identification and local routing functions, and especially in an emergency call service area. To make the matter worst, VoIP (Voice over IP) service providers tend to fail to provide an acceptable emergency call service through Internet telephony.

Accordingly, inadequate emergency call service through Internet telephony has become a problematic social issue as telephone subscribers regard and requires an emergency call service as a matter of right. Accordingly, it is necessary for Internet telephony service providers to develop a means for providing an emergency call service through Internet telephony.

### SUMMARY OF THE INVENTION

The present invention provides a method and system that can efficiently deliver a VoIP emergency call service in a next generation wired and wireless communication network.

The present invention also provides a method and system that can deliver an emergency call service to a mobile terminal with access to both licensed and unlicensed (open) networks.

The present invention further provides a method and system that enable a mobile terminal connected to an unlicensed mobile access (U MA) network to place an emergency call.

The present invention further provides a method and system that enable the acquisition of location information for a mobile terminal in communication with a UMA network for an emergency call service.

The present invention further provides a method and system that enable a mobile terminal in communication with a UMA network to directly place an emergency call without performing a rove out (roaming) to a licensed network.

In accordance with an exemplary embodiment of the present invention, an emergency call service method for a mobile terminal includes: placing, by the mobile terminal on an unlicensed network, an emergency call; forwarding, by the unlicensed network, the emergency call and an AP (access point) list related to an AP associated with the mobile terminal to a core network; searching for, by the core network, location information of the mobile terminal corresponding to the AP list; and sending, by the core network, an emergency report containing the location information of the mobile terminal to a safety manager.

In accordance with another exemplary embodiment of the present invention, an emergency call service system includes: a mobile terminal, an unlicensed network and a core network, wherein the mobile terminal obtains, when roving in from a licensed network to the unlicensed network, network information related to neighbor base stations of the licensed network, and registers the obtained network information in the core network, wherein the unlicensed network manages information of an AP that is the rove-in target as an AP list, and sends the AP list to the core network in response to an emergency call made by the mobile terminal, and wherein the core network obtains, when the network information is received, location information of the mobile terminal utilizing the network information, stores the obtained location information, and provides an emergency call service corresponding to the emergency call made by the mobile terminal on the basis of the AP list and the stored location information of the mobile terminal.

In a feature of the present invention, the emergency call service method and system enable the delivery of an emergency call service to a mobile terminal capable of accessing both licensed and unlicensed networks. Hence, a mobile terminal connected to an unlicensed network such as a UMA network can place an emergency call.

In addition, the method and system enable a mobile terminal connected to a UMA network to directly place an emergency call within the UMA network, unlike an existing approach requiring rove out to a licensed network for an emergency call. Hence, the time to handle an emergency call can be shortened, and the user in an emergency situation can rapidly receive an emergency call service. In sum, effective handling of emergency calls also benefits an Internet telephony service provider in terms of public safety and competitiveness.

### BRIEF DESCRIPTION OF THE DRAWINGS

The features and advantages of the present invention will be more apparent from the following detailed description in conjunction with the accompanying drawings, in which:

FIG. 1 illustrates the architecture of a system enabling a mobile terminal to transition between a licensed network and an unlicensed network;

FIG. 2 is a sequence diagram illustrating a procedure to register location information of a mobile terminal according to an exemplary embodiment of the present invention;

FIG. 3 is a sequence diagram illustrating a procedure to handle an emergency call of a mobile terminal according to an exemplary embodiment of the present invention;

FIG. 4 is a flow chart illustrating a procedure for a mobile terminal to register location information for an emergency call in a UMA network according to an exemplary embodiment of the present invention;

FIG. 5 is a flow chart illustrating a procedure for an MSC to register location information for an emergency call according to an exemplary embodiment of the present invention;

FIG. 6 is a flow chart illustrating a method of delivering an emergency call service to a mobile terminal according to exemplary embodiment of the present invention; and

FIG. 7 is a sequence diagram illustrating a procedure to delete location information of a mobile terminal according to an exemplary embodiment of the present invention.

### DETAILED DESCRIPTION OF THE INVENTION

Hereinafter, exemplary embodiments of the present invention are described in detail with reference to the accompanying drawings. The same reference symbols are used throughout the drawings to refer to the same or like parts. For the purposes of clarity and simplicity, detailed descriptions of well-known functions and structures incorporated herein may be omitted to avoid obscuring the subject matter of the present invention.

The present invention relates to a method and system for providing an emergency call service to a mobile terminal having access to both licensed and unlicensed networks. In particular, the method and system enable a mobile terminal connected to an unlicensed mobile access (UMA) network to directly place an emergency call without performing a roaming or rove out to a licensed network.

In the specification, a licensed network may be a cellular mobile communication network, such as a global system for mobile communications (GSM) network, universal mobile telecommunications system (UMTS) network, code division multiple access (CDMA) network, or wideband CDMA (WCDMA) network.

An unlicensed network may be a radio access network utilizing a UMA technology based on a license-free band, such as Wi-Fi, wireless local area network (WLAN), Bluetooth, radio-frequency identification (RFID), ultra wideband (UWB), and Zigbee. A license-free band is not exclusively licensed to a particular user or organization but is open to many users tolerating interference. The industrial, scientific and medical (ISM) band of 2.450 GHz is a representative example of a license-free band.

Specific examples of a licensed network and unlicensed network are well known in the art, thus are not described in detail. The words “licensed network” and “unlicensed network” are used as representative terms for such specific networks. In the specification, the terms “unlicensed network” and “UMA network” may be used interchangeably.

A mobile terminal of the present invention is a multimode mobile station that can access both a cellular mobile communication network and a UMA network enabling connection through an access point (AP) to a fixed IP network. In particular, the mobile terminal may access a licensed network such as a cellular mobile communication network and an unlicensed network such as a fixed IP network, and capable of transitioning between the licensed network and unlicensed network.

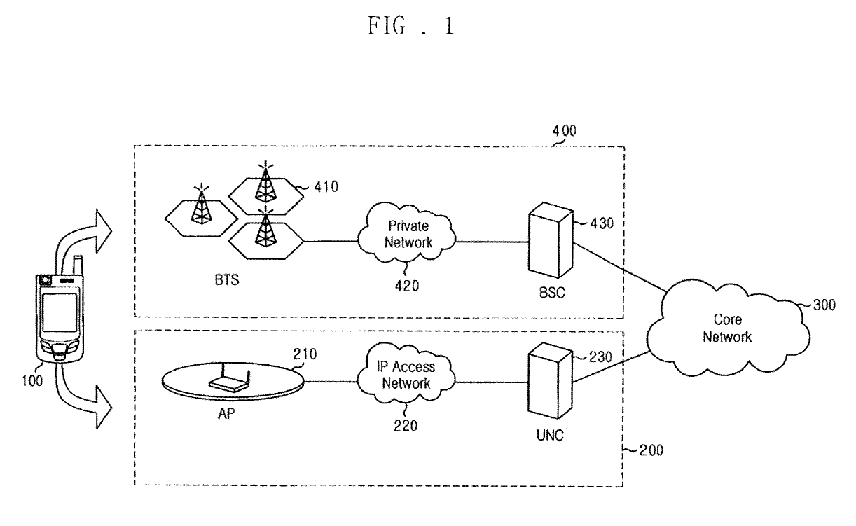

FIG. 1 illustrates the architecture of a system enabling a mobile terminal 100 in communication with a licensed network and an unlicensed network.

Referring to FIG. 1, the system includes a licensed network 400, a UMA network 200, and a core network 300. The licensed network 400 is a cellular mobile communication network and includes a base station (base transceiver station, BTS) 410, a private network 420, and a base station controller (BSC) 430 to provide communication services. The UMA network 200 is a fixed IP network and includes an AP 210, an IP access network 220, and a UMA network controller (UNC) 230 to provide communication services. The mobile terminal 100 can access both the licensed network 400 and the UMA network 200, and can transition between the licensed network 400 and the UMA network 200 with the assistance of the core network 300. In operation, when the mobile terminal 100 moves to an area covered by the AP 210, it can receive a telecommunication service through the UMA network 200 without interruption.

Recently, next-generation wired and wireless convergence technologies enable handovers between a licensed network and a UMA network. The UMA technology is a representative example of a next-generation convergence technology that provides a telecommunication service to a mobile terminal by the use of a license-free frequency band.

With emergency of UMA technology, the mobile terminal 100 at a location where a hot spot is installed may utilize a high-speed high-capacity data communication service or an Internet telephony (VoIP) service. That is, the UMA technology enables a mobile terminal to connect, through a Bluetooth or 802.11 system utilizing a license-free frequency band, to a licensed network such as a cellular mobile communication system.

Generally, the licensed network and UMA network are deployed as separate networks. Whereas the UMA network provides a high-speed service at a low cost and supports a narrow service area and low mobility, the licensed network provides a low-speed service at a high cost and supports a wide service area and high mobility.

For this reason, UMA technologies have been developed in recent years as a convergence means that combines a licensed network and an unlicensed network together for interworking. Multimode mobile stations capable of connecting to both a licensed network and unlicensed network have also been developed.

Utilizing the UMA technology, the UNC 230 can provide the mobile terminal 100 with voice, data, and supplementary services of an existing mobile communication system through an AP 210 (for example, a WLAN AP) without modification of equipment in the mobile communication system (for example, a base station, BSC, and MSC).

When the mobile terminal 100 employing the UMA technology enters an indoor room where strong WLAN signals are present, it can continue to use the current service through the UMA network 200 without service interruption. Thereby, the service quality can be enhanced for the mobile terminal 100, and system complexity can be reduced for the mobile communication operator.

However, in the application of an emergency call service, the mobile terminal 100 connected to the UMA network 200 may have to perform a handover or rove out to the licensed network 400. That is, the drawbacks of existing UMA network 200 is that it may fail to provide an emergency call service.

Accordingly, the teachings of the present invention provide an emergency call service to the mobile terminal 100 connected to the UMA network 200.

Hereinafter, the inventive method and system that enable the mobile terminal 100 to receive an emergency call service from the UMA network 200 will be explained with reference to FIGS. 1 to 7 for illustrative purposes. However, it is noted that the present invention is not limited to such an embodiment and other embodiments are also possible.

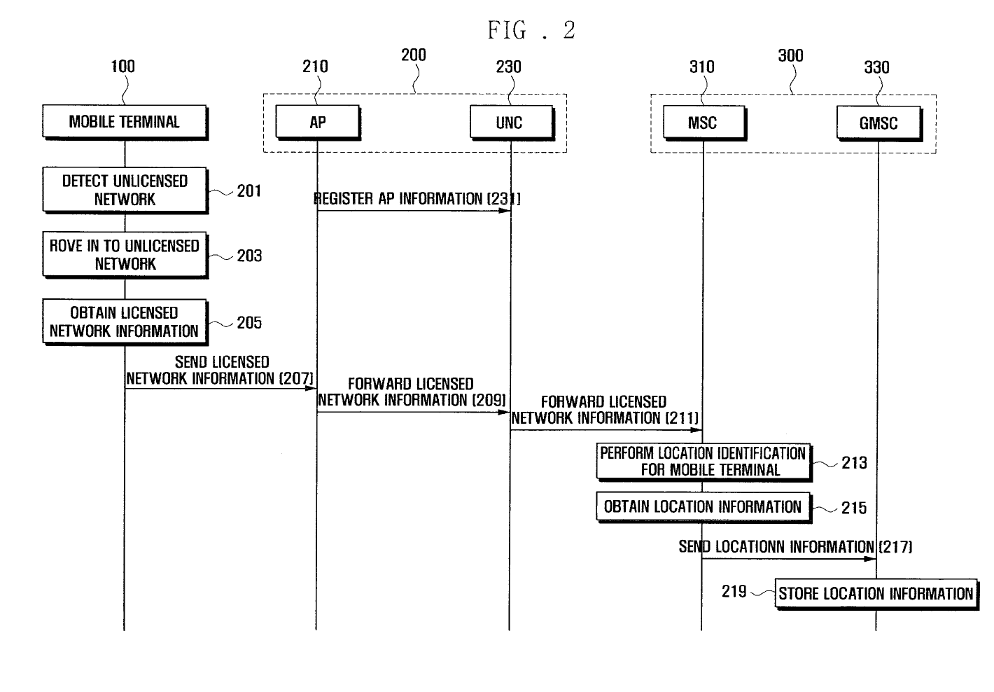

FIG. 2 is a sequence diagram illustrating a procedure for registering location information of a mobile terminal according to an exemplary embodiment of the present invention.

Referring to FIG. 2, the system of the present invention includes a mobile terminal 100, a UMA network 200, and a core network 300. Although not shown in FIG. 2, the system may also include various radio access networks (RAN) corresponding to the licensed networks 400.

The UMA network 200 may include an AP 210 and a UNC 230, and the core network 300 may include a mobile switching center (MSC) 310 and a gateway MSC (GMSC) 330. Here, the licensed network 400 is assumed to be a GSM network for illustrative purposes, but note that the GMSC 330 may be replaced with a network element corresponding to other networks employed as the licensed network 400.

Referring to FIG. 2, the mobile terminal 100 while in motion within the licensed network 400 detects an AP 210 of the UMA network 200 (201). When detecting a rove-in event, the mobile terminal 100 performs a rove in to the UMA network 200 (203).

Here, “rove-in” refers to a transition of the mobile terminal 100 from a base station 410 of the licensed network 400 to an AP 210 of the UMA network 200. A rove-in event may be generated, for example, when RSSI (received signal strength indication) for the licensed network 400 is lower than or equal to a preset reference value. Upon detection of a rove-in event, the mobile terminal 100 may perform rove in to the AP 210.

The mobile terminal 100 searches for information regarding neighbor base stations 410 to collect information on the licensed network 400 (205). Here, the licensed network information may include information on the serving network prior to rove in and information on a network near the AP 210 being the target for rove in. Specifically, the licensed network information includes information regarding the serving base station and at least two neighbor base stations in the licensed network 400 prior to rove in. Hence, the mobile terminal 100 obtains licensed network information containing information on at least three base stations.

The mobile terminal 100 sends the collected licensed network information to the AP 210 (the target for rove in) of the UMA network 200 (207). Upon reception of the licensed network information from the mobile terminal 100, the AP 210 forwards the licensed network information to the UNC 230 (209). The UNC 230 further forwards the licensed network information to the MSC 310 of the core network 300 (211).

Upon reception of the licensed network information through the UMA network 200 from the mobile terminal 100, the MSC 310 performs location identification for the mobile terminal 100 on the basis of the received licensed network information (213), and obtains the location information of the mobile terminal 100 (215). Here, location identification may be performed through, for example, triangulation based on the information as to three base stations.

Thereafter, the MSC 310 sends the obtained location information of the mobile terminal 100 to the GMSC 330 (217). Upon reception of the location information, the GMSC 330 stores the location information of the mobile terminal 100 (219). The GMSC 330 may maintain a database for location information of mobile terminals. For each mobile terminal, the GMSC 330 may store the mapping between the location information and identification information. The identification information may be an identification number or a telephone number assigned to a mobile terminal.

As described above, for an emergency call service to a mobile terminal 100 on the UMA network 200, the mobile terminal 100 obtains licensed network information containing information on at least three base stations upon rove in to the UMA network 200, and registers the licensed network information in the GMSC 330 of the core network 300. In the UMA network 200, the UNC 230 stores information on each AP 210 such as the MAC address, IP address, name and site location in the form of an AP list in advance (231). Hence, an emergency call service can be provided later in response to an emergency call made by the mobile terminal 100 on the basis of the AP lists and location information of the mobile terminal 100.

Hereinabove, a description is given regarding the registration of location information of the mobile terminal 100 upon rove in to the UMA network 200, and pre-registration of AP information as an AP list in the UNC 230. Next, a description is given for providing an emergency call service in response to an emergency call made by the mobile terminal 100 on the UMA network 200 using the information registered in advance.

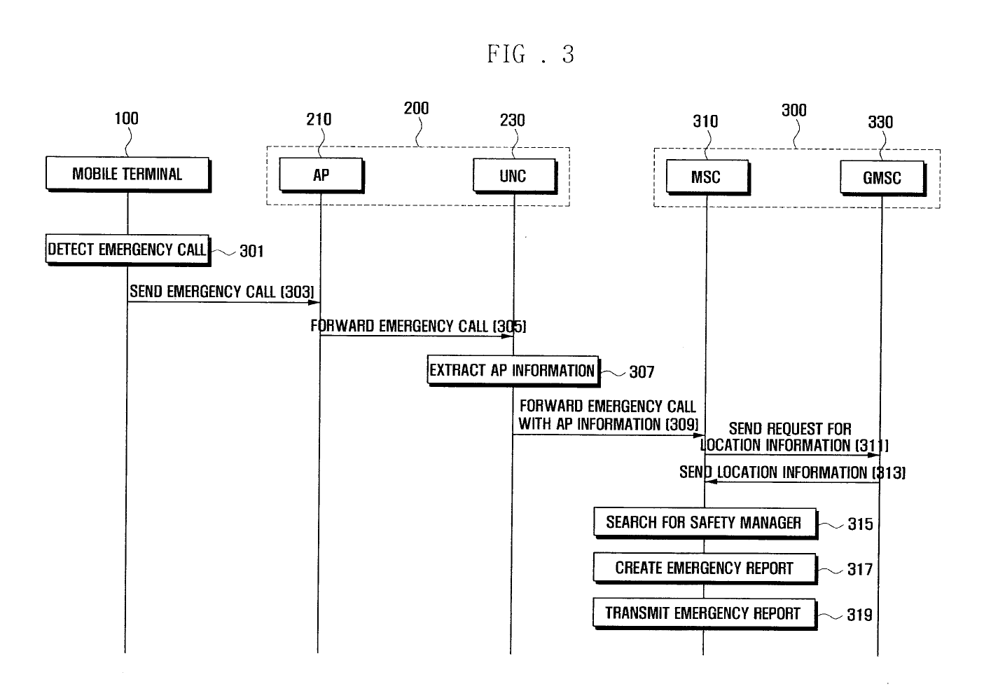

FIG. 3 is a sequence diagram illustrating a procedure to handle an emergency call of a mobile terminal according to an exemplary embodiment of the present invention.

Referring to FIG. 3, when the mobile terminal 100 detects an emergency call made by the user (301), it forwards the emergency call to the AP 210 of the UMA network 200 (303). Upon reception of the emergency call, the AP 210 forwards the emergency call to the UNC 230 (305).

Upon reception of the emergency call of the mobile terminal 100 from the AP 210, the UNC 230 retrieves information on the AP 210 (i.e., a pre-stored AP list) (307). As described before, the AP list includes the MAC address, IP address, name and site location of the AP 210.

The UNC 230 forwards the emergency call to the MSC 310 of the core network 300 together with the AP list associated with the AP 210 to which the mobile terminal 100 is connected (309).

Upon reception of the emergency call, the MSC 310 obtains the location information of the AP 210 from the AP list attached to the emergency call, and sends a request for location information of the mobile terminal 100 mapped to the AP location information to the GMSC 330 (311).

Upon reception of the location information request from the MSC 310, the GMSC 330 extracts location information of the mobile terminal 100 mapped to the AP location information. The GMSC 330 may identify one or more mobile terminals present within a preset geographical range (for example, a radius of 5 m) from the AP 210.

Thereafter, the GMSC 330 sends the extracted location and identification information of the mobile terminal 100 to the MSC 310 (313).

Upon reception of the location and identification information, the MSC 310 finds a safety manager corresponding to the location information of the mobile terminal 100 (315). The safety manager may be a public safety answering point (PSAP) or public safety agency (PSA) near the location of the mobile terminal 100.

Individual safety managers may be mapped with specific geographical locations, and pre-stored in a database. Hence, the MSC 310 can find a safety manager corresponding to specific location information.

Thereafter, the MSC 310 creates an emergency report (317), and transfers the emergency call to the found safety manager together with the emergency report (319). The emergency report may include at least one of the location information of the mobile terminal 100 and location information of the AP associated with the mobile terminal 100.

Next, a description relating to operations of the mobile terminal 100 and the MSC 310 in relation to the emergency call service is provided. However, note that the teachings of the present invention are not limited to the following description of the mobile terminal 100 and the MSC 310.

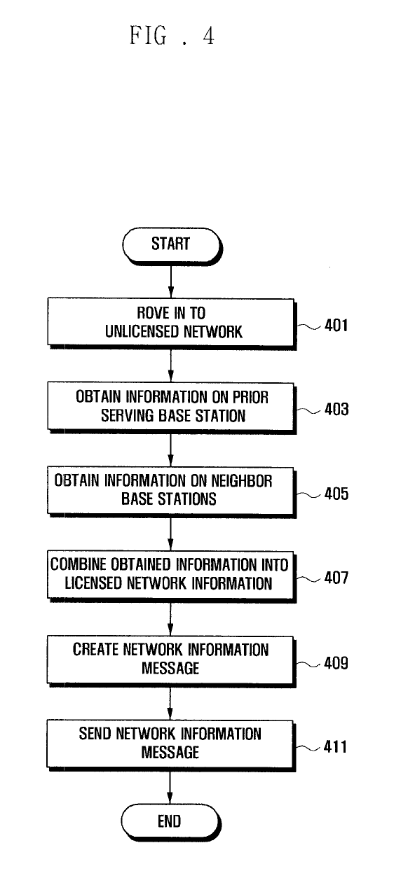

FIG. 4 is a flow chart illustrating a procedure for a mobile terminal 100 to register location information for an emergency call in a UMA network according to an exemplary embodiment of the present invention.

Referring to FIG. 4, the mobile terminal 100, while in motion within the licensed network 400, may detect an AP 210 of the UMA network 200. That is, the mobile terminal 100 may detect a rove-in event.

Upon detection of a rove-in event, the mobile terminal 100 performs rove in to the AP 210 through a given procedure (401). A rove-in event may be generated, for example, when RSSI for the licensed network 400 is lower than or equal to a preset reference value.

Upon rove in to the AP 210, the mobile terminal 100 searches for information regarding neighbor base stations to collect licensed network information. That is, the mobile terminal 100 obtains information regarding the connected base station (i.e., serving base station) prior to rove in to the AP 210 (403), and further obtains information regarding at least two neighbor base stations near the AP 210 (405).

The mobile terminal 100 collect the information on the serving base station and the information on the at least two neighbor base stations (407). The mobile terminal 100 creates a network information message containing the information of the serving base station and the information of the neighbor base stations (409), and sends the created network information message to the AP 210 (i.e., the target for rove in) of the UMA network 200 (411). The network information message includes licensed network information. In particular, the network information message includes information regarding the serving base station and at least two neighbor base stations in the licensed network prior to rove in. Hence, the mobile terminal 100 obtains network information containing a licensed network information on at least three base stations.

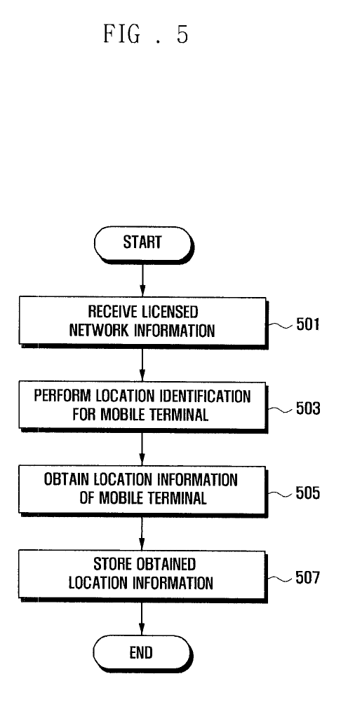

FIG. 5 is a flow chart illustrating a procedure for the MSC 310 to register location information for an emergency call according to an exemplary embodiment of the present invention.

Referring to FIGS. 4 and 5, when the MSC 310 receives a network information message from the UNC 230 of the UMA network 200 (501), it performs location identification for the mobile terminal 100 on the basis of licensed network information (i.e., information on at least three base stations) contained in the received network information message (503). Location identification may be performed through triangulation.

The MSC 310 obtains the location information of the mobile terminal 100 (505), and stores the obtained location information of the mobile terminal 100 (507). Here, the obtained location information may be transferred to the GMSC 330 and be stored in the GMSC 330. Identification information of the mobile terminal 100 may also be transferred to the GMSC 330, and the GMSC 330 may store mappings between the location information and identification information.

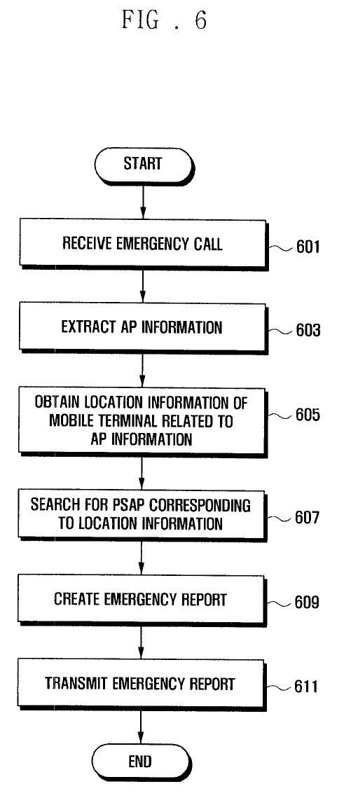

FIG. 6 is a flow chart illustrating a method of delivering an emergency call service to a mobile terminal 100 according to another exemplary embodiment of the present invention. In FIG. 6, the MSC 310 handles an emergency call made by the mobile terminal 100 in communication with the UMA network 200.

Referring to FIG. 6, when the MSC 310 receives an emergency call via the UNC 230 of the UMA network 200 from the mobile terminal 100 (601), it extracts information on the AP associated with the mobile terminal 100 (603). Extraction of the AP information may be performed using the AP list. Specifically, upon reception of the emergency call of the mobile terminal 100 from the AP 210, the UNC 230 retrieves information on the AP 210 (i.e., a pre-stored AP list). As described before, the AP list includes the MAC address, IP address, name and site location of the AP 210.

The MSC 310 obtains location information of the mobile terminal 100 related to the extracted AP information (605). At step 605, the MSC 310 sends a request for location information of the mobile terminal 100 mapped to the AP information to the GMSC 330. Upon reception of the location information request from the MSC 310, the GMSC 330 extracts location information of the mobile terminal 100 mapped to the AP location information. The GMSC 330 may identify one or more mobile terminals present within a preset geographical range (for example, a radius of 5 m) from the AP 210. Thereafter, the GMSC 330 sends the extracted location and identification information of the mobile terminal 100 to the MSC 310.

The MSC 310 searches for a safety manager present at a geographical area corresponding to the found location information of the mobile terminal 100 (607). A desired safety manager may be found in a database storing mappings between safety managers and geographical locations.

The MSC 310 creates an emergency report (609), and transfers the emergency call to the found safety manager together with the emergency report (611). The emergency report may include at least one of the location information of the mobile terminal 100 and location information of the AP associated with the mobile terminal 100.

Hereinabove, a description is given regarding the registering location information of a mobile terminal 100 roving in to the UMA network 200, and regarding handling an emergency call made by the mobile terminal 100 on the UMA network 200.

Next, a description is about removing registered location information when the mobile terminal 100 roves out from the UMA network 200 to the licensed network 400. However, a removal of registered location information is not a mandatory operation, but is preferred for maximize the system efficiency. That is, registering and removing location information according to the connection state of the mobile terminal 100 may enhance system efficiency in terms of database management and data retrieval.

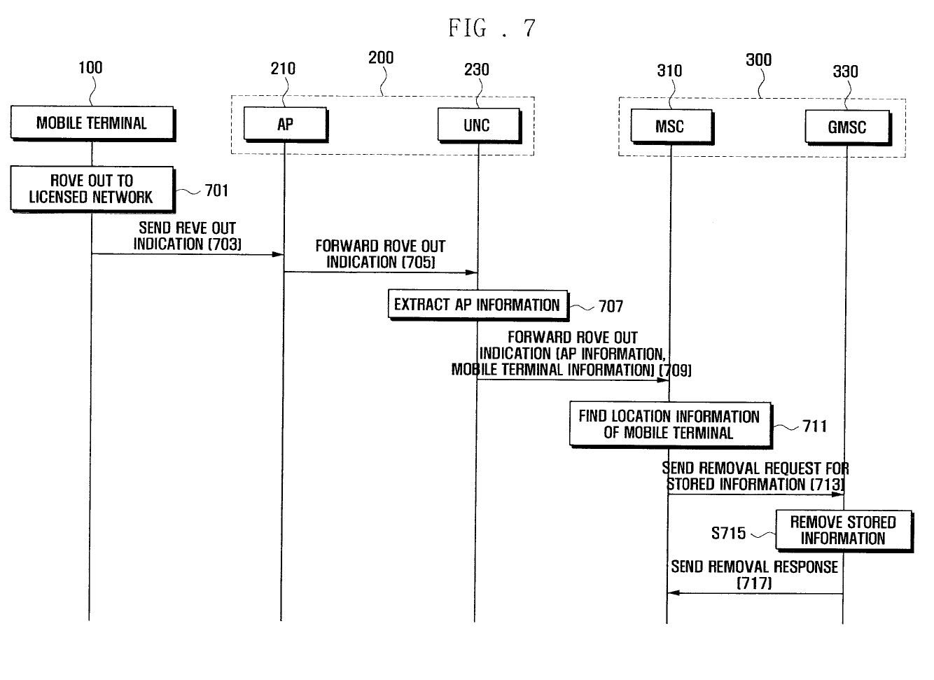

FIG. 7 is a sequence diagram illustrating a procedure to delete location information of a mobile terminal according to an exemplary embodiment of the present invention.

Referring to FIGS. 1 to 3, when the mobile terminal 100 on the UMA network 200 detects a rove-out event, it performs rove out to the licensed network 400 (701). A rove-out event may be generated, for example, when RSSI for the AP 210 is lower than or equal to a preset reference value. Here, “rove out” refers to a transition of the mobile terminal 100 from an AP 210 of the UMA network 200 to a base station 410 of the licensed network 400.

Upon detection of a rove-out event, the mobile terminal 100 selects one of the neighbor base stations of the licensed network 400, and roves out to the selected base station. The rove-out procedure may be performed according to the employed standard.

Upon rove out, the mobile terminal 100 sends a rove out indication to the associated AP 210 of the UMA network 200 (703). Upon reception of the rove out indication from the mobile terminal 100, the AP 210 forwards the rove out indication to the UNC 230 (705).

Upon reception of the rove out indication from the AP 210, the UNC 230 extracts information on the AP 210 (707). AP information may be extracted from the registered AP list.

Thereafter, the UNC 230 forwards the rove out indication together with the AP list (AP information) and identification information of the mobile terminal 100 to the MSC 310 of the core network 300 (709).

Upon reception of the rove out indication, the MSC 310 obtains the AP information attached to the rove out indication, and finds location information of the mobile terminal 100 mapped to the AP information (711). The MSC 310 may perform step 711 together with the GMSC 330.

The MSC 310 sends a request for removal of the location information of the mobile terminal 100 to the GMSC 330 (713). Upon reception of the removal request, the GMSC 330 removes the stored location information as to the mobile terminal 100 (715), and sends a removal response as a reply to the removal request to the MSC 310 (717).

The above-described methods according to the present invention can be realized in hardware or as software or computer code that can be stored as machine readable code in a medium such as a ROM, an RAM, a floppy disk, a hard disk, a flash memory, or a magneto-optical disk, or downloaded over a network, so that the methods described herein can be rendered in such software using a general purpose microprocessor, general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein.

Although exemplary embodiments of the present invention have been described in detail hereinabove, it should be understood that many variations and modifications of the basic inventive concept herein described, which may appear to those skilled in the art, will still fall within the spirit and scope of the exemplary embodiments of the present invention as defined in the appended claims.

What is claimed is:

1. An emergency call service method for a mobile terminal, comprising:
requesting, by the mobile terminal, an emergency call and determining an access point (AP) of an unlicensed network associated with the mobile terminal;
forwarding, by the unlicensed network, the emergency call and an AP list related to the AP associated with the mobile terminal to a core network;
searching for, by the core network, location information of the mobile terminal based on the AP list; and
transmitting, by the core network, an emergency report containing the location information of the mobile terminal to a safety manager.

2. The emergency call service method of claim 1, wherein searching for location information comprises finding location information of the mobile terminal based on AP location information of the AP list.

3. The emergency call service method of claim 2, wherein searching for location information comprises finding a specific mobile terminal whose location information corresponds to the AP location information in a database of the core network, and obtaining location information of the found mobile terminal.

4. The emergency call service method of claim 2, wherein the emergency report comprises identification information and location information of the mobile terminal.

5. The emergency call service method of claim 4, wherein transmitting the emergency report further comprises transferring the emergency call originating from the mobile terminal to the safety manager.

6. The emergency call service method of claim 4, wherein the emergency report further comprises the AP location information.

7. The emergency call service method of claim 3, further comprising registering network information by:
sending, by the mobile terminal when roving in from a licensed network to the unlicensed network, network information related to neighbor base stations of the licensed network to the core network; and
obtaining, by the core network, location information of the mobile terminal through location identification based on the network information, and storing the obtained location information in the database.

8. The emergency call service method of claim 7, wherein registering network information comprises mapping location information of the mobile terminal to identification information thereof for storage.

9. The emergency call service method of claim 7, further comprising:
sending, by the mobile terminal when roving out from the unlicensed network to the licensed network, a rove out indication to the unlicensed network;
forwarding, by the unlicensed network, the rove out indication together with AP information of the AP associated with the mobile terminal to the core network; and
deleting, by the core network, location information of the mobile terminal corresponding to the AP information from the database.

10. An emergency call service system comprising a mobile terminal, an unlicensed network and a core network,
wherein the mobile terminal obtains, when roving in from a licensed network to the unlicensed network, network information related to neighbor base stations of the licensed network, and registers the obtained network information in the core network,
wherein the unlicensed network manages information of an AP that is the rove-in target as an AP list, and sends the AP list to the core network in response to an emergency call made by the mobile terminal, and
wherein the core network obtains, when the network information is received, location information of the mobile terminal utilizing the network information, stores the obtained location information, and provides an emergency call service corresponding to the emergency call made by the mobile terminal on the basis of the AP list and the stored location information of the mobile terminal.

11. The emergency call service system of claim 10, wherein the core network comprises a mobile switching center (MSC) and a gateway MSC (GMSC), and wherein the MSC searches for location information of the mobile terminal utilizing the network information and registers a mapping between the found location information of the mobile terminal and identification information thereof in the GMSC.

12. The emergency call service system of claim 11, wherein the GMSC of the core network stores the location information of the mobile terminal in a database, and the MSC searches for, in response to the emergency call, a mobile terminal present in a geographical region corresponding to the AP information and obtains location information of the found mobile terminal from the GMSC.

13. The emergency call service system of claim 11, wherein the core network sends, in response to the emergency call, an emergency report containing the location information and identification information of the mobile terminal to a safety manager.

14. The emergency call service system of claim 13, wherein the core network transfers the emergency call originating from the mobile terminal to the safety manager when sending the emergency report.

15. The emergency call service system of claim 13, wherein the emergency report further comprises location information of the AP.

16. The emergency call service system of claim 12, wherein the mobile terminal sends, when roving out from the unlicensed network to the licensed network, a rove out indication to the unlicensed network.

17. The emergency call service system of claim 16, wherein the unlicensed network forwards the rove out indication together with AP information of an AP associated with the mobile terminal to the core network.

18. The emergency call service system of claim 17, wherein the core network deletes, upon reception of the rove out indication, location information of the mobile terminal corresponding to the AP information from the database of the GMSC.
